(19) United States
(12) Patent Application Publication
(10) Pub. No.: US 2026/0341295 A1
(43) Pub. Date: Oct. 29, 2026

(54) DIRECTIONAL NOISE REDUCTION AND VOICE ENHANCEMENT SYSTEM BASED ON MICROPHONE ARRAY

(71) Applicant: Jueqing HE, Guangzhou (CN)

(72) Inventor: Jueqing HE, Guangzhou (CN)

(21) Appl. No.: 19/658,913

(22) Filed: Apr. 27, 2026

(30) Foreign Application Priority Data
Apr. 28, 2025 (CN) 202510546514.5

(51) Int. Cl. G10L 21/0232; G06V 40/16; G10L 21/0216; G10L 21/028; H04R 1/40; H04R 3/00; H04R 29/00

(52) U.S. Cl. CPC G10L 21/0232; G06V 40/166; G10L 21/028; H04R 1/406; H04R 3/005; H04R 29/005; G10L 2021/02166; H04R 2410/01

(57) ABSTRACT

The present disclosure relates to the technical field of speech collection and processing technologies, and provides a directional noise reduction and voice enhancement system based on a microphone array. The system includes: a collection device with the microphone array and configured to control the microphone array to collect sound waves to form a first audio based on collection control data corresponding to collection direction data; and a processing device configured to perform directional noise reduction and voice enhancement based on the first audio and the collection direction data to obtain a target voice; an umbrella-shaped collection head arranged on an end of the collection device and including at least four concave collection portions to form sound wave reflection and focusing structures, and a receiving end of at least one microphone of the microphone array arranged within one of the sound wave reflection and focusing structures.

### BACKGROUND

### 1. Cross-Reference To Related Application

This application claims the benefit of priority from Chinese Patent Application No. CN202510546514.5 entitled “DIRECTIONAL NOISE REDUCTION AND VOICE ENHANCEMENT SYSTEM BASED ON MICROPHONE ARRAY” and Filed on April 28, 2025, the content of which is hereby incorporated by reference in its entire by reference.

### 2. Technical Field

The present disclosure generally relates to the field of voice collection and processing and artificial intelligence technologies, and especially relates to a directional noise reduction and voice enhancement system based on a microphone array.

### 3. Description of Related Art

The accuracy of voice recognition is a reliability foundation of scenes such as intelligent homes, vehicle-mounted interaction etc., and voice quality directly affects the recognition performances thereof. Conventional voice enhancement technologies adopt a separate architecture of “fixed omnidirectional collection and backend processing”. The fixed omnidirectional collection way is to use of a fixed collection mode together with performing omnidirectional collection. A noise spectrum highly aliased with human voices are occurred in signals that are collected by the fixed collection mode in the complex sound environments, and the omnidirectional collection mode means that the collection device can receive sound waves from all directions indiscriminately, so that a large amount of noise signals are contained thereof, and the noise signals are mixed with desired voice signals to be collected. When the noise spectrum is highly aliased with the human voices, and audios with the large amount of noise signals is transmitted to the backend for being performed voice quality improvement processing, the backend processing algorithm faces a great challenge in improving the voice quality, resulting in poor effect of backend processing in improving the voice quality.

### SUMMARY

The technical problems to be solved: in view of the shortcomings of the related art, the present disclosure provides a directional noise reduction and voice enhancement system based on a microphone array which can solve the technical problem that the effect of improving the voice quality is poor in the related art by adopting the separate architecture of “the fixed omnidirectional collection way and backend processing”.

In a first aspect, a directional noise reduction and voice enhancement system based on a microphone array according to an embodiment of the present disclosure includes:
a collection device including the microphone array and configured to control the microphone array to collect sound waves to form a first audio based on collection control data corresponding to collection direction data;
a processing device configured to perform directional noise reduction and voice enhancement based on the first audio and the collection direction data to obtain a target voice; and wherein
an umbrella-shaped collection head is arranged on an end of the collection device and comprises at least four concave collection portions to form sound wave reflection and focusing structures, and a receiving end of at least one microphone of the microphone array is arranged within one of the sound wave reflection and focusing structures.

The directional noise reduction and voice enhancement system based on the microphone array of the present disclosure is provided that, firstly, the collection device controls the microphone array to collect based on the collection control data corresponding to the collection direction data. The defect that excessive noise can be collected in the conventional omnidirectional collection way is avoided in the directional focused collection mode, the audio signal in the target direction (the main collection direction) can be selectively collected, and the noise collection in the non-target direction (the auxiliary collection direction) can be reduced. Secondly, the processing device is configured to perform the directional noise reduction and voice enhancement based on the first audio and the collection direction data. The backend is operated based on the collection direction data, thereby greatly improving the noise reduction effect and effectively suppressing the noise in the voice. The collection portion of the umbrella-shaped collection head at one end of the collection device is inwards concave to form the sound wave reflection focusing structure, the receiving end of at least one microphone in the microphone array is positioned within the structure, the specific setting of the collection portion is well matched with the directional focused collection mode, the directional collection is further realized, and the audio signals that are collected are more targeted in the direction. The present disclosure integrally improves the capabilities of system directional noise reduction and voice enhancement and improves the quality of the target voice through the special arrangement of the collection direction data and the umbrella-shaped collection head.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of a directional noise reduction and voice enhancement system based on a microphone array in accordance with an embodiment of the present disclosure.

FIG. 2 is a structural diagram of the directional noise reduction and voice enhancement system of FIG. 1.

FIG. 3 is a schematic view of a collection device of the directional noise reduction and voice enhancement system of FIG. 1.

FIG. 4 is a top view of the collection device of FIG. 3.

FIG. 5 is a schematic view of a collection portion of the collection device of FIG. 3.

The element labels according to the embodiment of the present disclosure shown as below:

1 collection device, 11 hand-held portion, 12 umbrella-shaped collection head, 121 collection portion, 1211 opening end, 1221 first receiving end of heart-shaped microphone, 1222 second receiving end of omnidirectional microphone, 1223 sound wave reflection focusing structure, 13 first controller, 14 second input member, 15 pilot lamp, 16 microphone array, 17 direction detection member, 18 image pickup member, 19 first communication member, 2 processing device, 21 second controller, 22 playing member, 23 second communication member, 24 first input member, 3 sound wave, 4 remote control.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skill in the related art on the premise of no creative work are within the protection scope of the present disclosure.

The directional noise reduction and voice enhancement system based on the microphone array of the present disclosure is mainly applied to complex scenarios such as conference scenes, interview scenes, and chorus scenes etc.

In large conference rooms, there is often background noise that is generated by personnel movement and equipment operation (such as air-conditioners, projector fans, etc.). The system can perform directional collection based on a direction of a speaker, with a focus on collecting a voice of the speaker. Through performing directional noise reduction and voice enhancement, participants can clearly hear the speech and avoid being disturbed by surrounding noise. In remote video conferences, participants may be in various environments with significant differences in environmental noise. The system can perform directional collection and optimization processing on voices surrounding each participant, improving the quality of voice transmission to make communication in remote conferences smoother.

In interview scenarios, whether conducting news interviews in noisy streets, lively event venues, or special places such as factories with machine noise, the system can selectively collect voices of an interviewee, reduce surrounding environmental noise, ensure clear and audible interview contents, to be convenient for later stage preparation and propagation.

In places such as choir rehearsal halls or music halls, although the environment is relatively quiet, there may still be some disruptive sounds, such as slight coughing from the audience and the running sound of air-conditioners. The directional noise reduction and voice enhancement system based on the microphone array can directionally collect voices of choir teams and reduce background noise, simultaneously enhance the overall effect of the choir sound, make the harmony of the choir singing clearer and fuller, help the conductor to control the choir effect, and also provide the audiences with a better auditory experience.

During outdoor choir performances, there will be more noise interference, such as wind and noisy crowds. The system can directionally focus on sounds of choral performers, effectively eliminate external noise, ensure the purity and listenability of choir sounds, and guarantee the quality of the choir performance.

In the present disclosure, audios refer to all physical signals of audible sound waves, which includes voices, music, environmental noise, etc. The voice refers specifically to semantic sound waves generated by human vocal organs, which carry language information (such as Chinese and English) and have clear phonemes, intonation, and rhythmic structures.

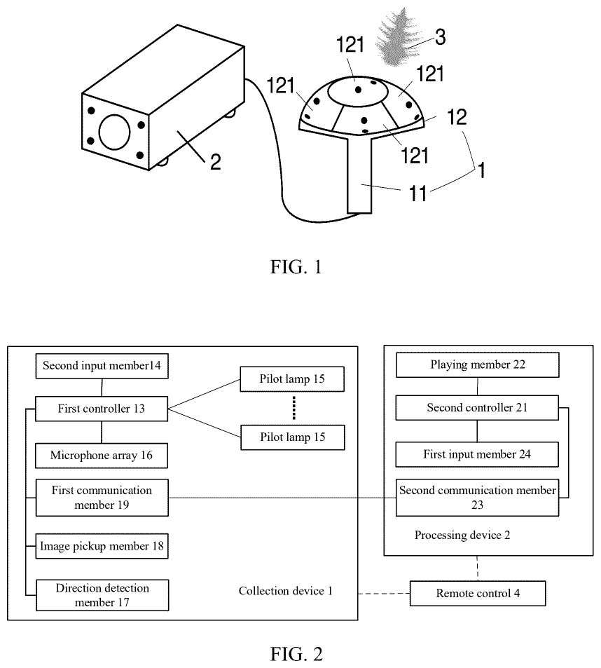

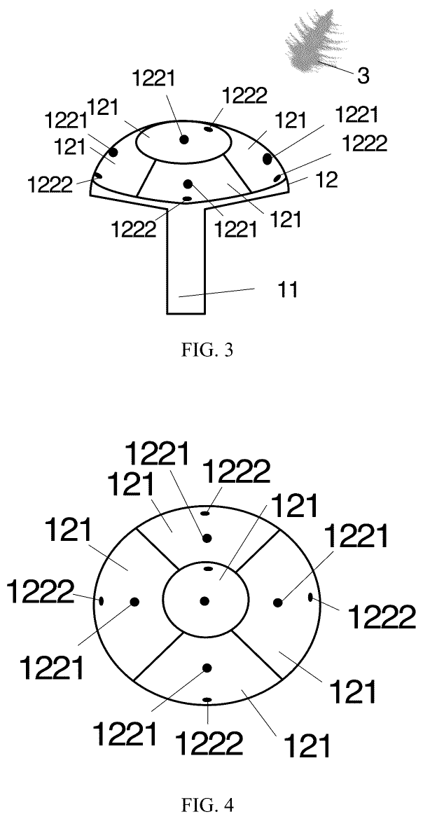

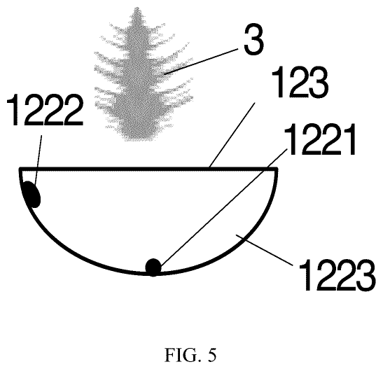

Referring to FIG. 1 to FIG. 5. The present disclosure provides a directional noise reduction and voice enhancement system based on a microphone array, which includes:
a collection device 1 including a microphone array 16 and configured to control the microphone array to collect sound waves to form a first audio based on collection control data corresponding to collection direction data;
processing device 2 configured to perform directional noise reduction and voice enhancement based on the first audio and the collection direction data to obtain a target voice; and wherein
an umbrella-shaped collection head 12 is arranged on an end of the collection device 1 and includes at least four concave collection portions 121 to form sound wave reflection and focusing structures 1223, and a receiving end of at least one microphone (labels 1221, 1222 as shown in FIG. 3) of the microphone array 16 is arranged within one of the sound wave reflection and focusing structures 1223.

The microphone array 16 includes a plurality of microphones.

A first controller 13 is arranged in the collection device 1, which is a core control component of the collection device 1. The first controller 13 is responsible for coordinating the operation of various electronic control components within the collection device 1. For example, the first controller 13 can control an order of opening and closing each microphone in the microphone array 16, and adjust the sensitivity thereof etc. By precisely controlling these electronic components, it is ensured that the collection device 1 collects sound waves 3 in a predetermined manner to form an audio (that is, a first audio).

The first controller 13 is implemented through hardware circuits and software programming. The hardware includes microprocessors, and control circuits, etc. The microprocessor is taken as the core, and the software programming sets working parameters of each electronic control component, such as defining a working mode of the microphone through codes. The control circuit is responsible for transmitting instructions, enabling the microprocessor to accurately control various components and achieve functions such as sequentially activating the microphones, for ensuring that the microphone array 16 efficiently collects sound waves 3.

A second controller 21 is arranged in the processing device 2 and configured to control a working of the various electronic control components inside the processing device 2.

The second controller 21 is implemented based on the collaboration of hardware and software. The hardware includes processing chips, and storage units, etc. The processing chip executes instructions of the software, and the software writes algorithm logic based on processing requirements. The storage unit is configured to store data and programs, and determine a processing flow of each electronic control component through software algorithms, such as controlling operations of the component according to algorithms during performing noise reduction processing, to achieve effective processing of input audios.

The first communication member 19 (that is the electronic control component) of the collection device 1 and the second communication member 23 (that also is the electronic control component) of the processing device 2 are communication connection with each other through a wireless communication technology (such as a Bluetooth) or a wired communication technology (such as data cables). The first controller 13 is electrically connected to the first communication member 19, and the second controller 21 is electrically connected to the second communication member 23.

The collection device 1 and the processing device 2 are communication connection with each other. The collection device 1 and the processing device 2 can be set independently or integrated into the same device.

The collection direction data includes: a main collection direction and an auxiliary collection direction. There are one of more main collection directions, and there can be any of zero, one or more auxiliary collection directions.

The collection direction data can be pre-set by an user, input by the user during the collection process, or automatically determined by the program of the present disclosure based on a preset direction determination algorithm.

The collection control data includes: main collection data and auxiliary collection data. The main collection data is configured to control a gain of each microphone corresponding to the main collection direction. The auxiliary collection data is configured to control the microphone corresponding to the auxiliary collection direction to be turned off or collect an increase noise reduction intensity thereof.

The collection device 1 is configured to determine the collection control data based on the collection direction data.

Optionally, the collection device 1 is configured to use a lookup table method to determine the collection control data based on the collection direction data.

Optionally, the collection device 1 inputs the collection direction data into a first model that is pre-trained for performing classification prediction, to select a vector element with the largest value from predicted vectors, and take the control data corresponding to the selected vector element as the collection control data.

The first model that is pre-trained is a multi-classification model that is pre-trained. A model structure and a model training method of the first model can be selected from the related art.

The processing device 2 is configured to determine a noise reduction scheme and a voice enhancement scheme based on the collection directional data, perform directional noise reduction on the first audio based on the noise reduction scheme that is determined, and perform vocal separation and voice enhancement on the audio (that is the first audio) that is directionally denoised based on the determined voice enhancement scheme to obtain high-quality voices to be taken as the target voice.

The directional noise reduction refers to reducing the noise reduction intensity to ensure the clarity of useful sounds in the desired direction (i.e., the main collection direction). For audios in unwanted directions (i.e. the auxiliary acquisition direction), according to an increase noise reduction intensity that is set, and a signal processing technology is used to suppress the noise, thereby achieving different noise reduction effects in different directions.

Optionally, the processing device 2 is configured to determine the noise reduction scheme by using a lookup table method based on the collected directional data, and determine the voice enhancement scheme by using the lookup table method based on the collection directional data.

Optionally, the collection direction data is input into a second model that is pre-trained for being performed classification prediction, to select the vector element with the highest value from the predicted vectors corresponding to the noise reduction, and take a scheme corresponding to a classification category (i.e., a scheme identifier) that is corresponding to the selected vector element, as the noise reduction scheme. Among the vector elements corresponding to the voice enhancement from the predicted vectors that are obtained, selecting the vector element with the highest value, and taking a scheme corresponding to the classification category (i.e., the scheme identifier) that is corresponding to the selected vector element, as the voice enhancement scheme.

The second model that is pre-trained is a multi-classification model that is pre-trained. A model structure and a model training method of the second model can be selected from the related art.

The scheme identifier is data that can uniquely identify a scheme, such as a scheme name, and a scheme ID, etc.

The collection portion 121 is concaved inwards to form the sound wave reflection focusing structure 1223, so that the sound waves 3 in a specific direction range can enter the sound wave reflection focusing structure 1223, and the sound waves 3 outside the specific direction range are blocked outside the sound wave reflection focusing structure 1223, in this way, sound wave screening can be performed on the structural arrangement of the collection portion 121, to reduce the difficulty of directional noise reduction for the processing device 2.

The receiving end of at least one microphone in the microphone array 16 is located within one of the sound wave reflection focusing structures 1223, so that the receiving end of the microphone in the sound wave reflection focusing structure 1223 only receives the sound waves within the sound wave reflection focusing structure 1223, thereby realizing directional collection thereof.

Adjacent collection portions 121 can be connected seamlessly. The adjacent collection portions 121 can also be connected with each other by flexible soundproofing materials (such as silicone sealing strips), to avoid sound wave interference caused by structural resonance thereof.

An opening diameter and a depth of the umbrella-shaped collection head 12 can be set as required, which are not limited herein.

The entire umbrella-shaped collection head 12 can be printed by using a 3D (three-dimensional) printing technology or the collection portion 121 can be independently printed and then assembled into the umbrella-shaped collection head 12, or the umbrella-shaped collection head 12 can be manufactured by opening a mold in an integrated manner or the collection portion 121 can be independently manufactured and then assembled into the umbrella-shaped collection head 12. The umbrella-shaped collection head 12 that is printed by the 3D printing technology can avoid an influence that manufacturing errors are caused by manufacturing the mold on the directional collection effect.

Firstly, a three-dimensional model of the umbrella-shaped collection head 12 is created by using 3D modeling software, and parameters such as a shape, a size, and an internal structure are precisely set to form a model file. And then, the model file is then imported into a 3D printer. A suitable printing material is selected, such as durable plastic. The 3D printer stacks the materials layer by layer according to the model file, and finally prints out a physical object of the umbrella-shaped collection head 12.

Optionally, the collection portion 121 is concave with a parabolic or spherical (preferably the parabolic) concave structure, that is, the sound wave reflection focusing structure 1223, so as to ensure that the sound wave is focused to be reflected to the receiving end of the microphone. That is to way, the sound wave reflection focusing structure 1223 includes a cavity surrounded by inner walls. The microphone receives the sound waves in the cavity.

The other end of the collection device 1 can be a hand-held portion 11 for being handheld used or a supporting base. The collection device 1 is placed on a plane (such as the ground, a desktop) by the supporting base.

Referring to FIG. 1 and FIGS. 3-5, it can be understood that there are five collection portions 121 schematically shown, and that the collection portion 121 arranged on the top, and four collection portions 121 are disposed around the top collection portion 121. It is understood that the number of the collection portions 121 can be preferably four to eight. In addition to the distribution patterns shown in FIG. 1 and FIGS. 3-5, there can be other distribution patterns for each collection portion 121, which are not limited herein.

A shape of an opening end 1211 of the collection portion 121 can be circular or other shapes, which is not limited herein.

The sound wave 3 enters the sound wave reflection focusing structure 1223 from the outside of the collection portion 121 through the open end 1211, and is received by the receiving end of the microphone in the collection portion 121 to form an audio.

In an embodiment of the present disclosure, the collection device 1 controls the microphone array to collect based on the collection control data corresponding to the collection direction data. The defect that excessive noise can be collected in the conventional omnidirectional collection way is avoided in the directional focused collection mode, the audio signal in the target direction (the main collection direction) can be selectively collected, and the noise collection in the non-target direction (the auxiliary collection direction) can be reduced. Secondly, the processing device 2 is configured to perform the directional noise reduction and voice enhancement based on the first audio and the collection direction data. The backend is operated based on the collection direction data, thereby greatly improving the noise reduction effect and effectively suppressing the noise in the voice. The collection portion 121 of the umbrella-shaped collection head 12 at one end of the collection device 1 is inwards concave to form the sound wave reflection focusing structure 1223, the receiving end of at least one microphone in the microphone array 16 is positioned within the structure, the specific setting of the collection portion 121 is well matched with the directional focused collection mode, the directional collection is further realized, and the audio signals that are collected are more targeted in the direction. The present disclosure integrally improves the capabilities of system directional noise reduction and voice enhancement and improves the quality of the target voice through the special arrangement of the collection direction data and the umbrella-shaped collection head 12.

Referring to FIG. 1 and FIGS. 3-5, in an embodiment of the present disclosure, the types of microphones include a heart-shaped microphone and an omnidirectional microphone, wherein a first receiving end 1221 of the heart-shaped microphone is formed at a center of the sound wave reflection focusing structure 1223, and at least one second receiving end 1222 of the omnidirectional microphone is formed on an edge of the sound wave reflection focusing structure 1223.

It can be understood that in the collection portion 121, the receiving end of the microphone is located between the opening end 1211 and the center position of the sound wave reflection focusing structure 1223.

Specifically, the concave structure of the collection portion 121 reflects the incident sound wave to the first receiving end 1221 of the heart-shaped microphone that is arranged at the center position.

The first receiving end of the heart-shaped microphone has unique pickup characteristics, and is most sensitive to the sound waves in front thereof, and is insensitive or less sensitive to the sound waves other than in front thereof, thereby forming a heart-shaped pickup pattern. When receiving the sound wave, it can focus well on the sound waves that are transmitted from the front, and effectively suppress the interference of the sound waves from the back and the sides thereof.

The first receiving end of the heart-shaped microphone typically has a diaphragm arranged at the center, and is surrounded around by a specially designed sound-insulation structure. There is no obstruction in front of the diaphragm, which is conducive to receiving the sound waves directly in front thereof. There are reflection or sound absorption designs arranged on two sides and the rear of the diaphragm, so that the diaphragm is sensitive to the sound waves on the front thereof, thereby reducing to receive the sound waves on the side and the rear thereof, to form heart-shaped pickup mode thereof.

The second receiving end of the omnidirectional microphone can receive the sound waves in all directions, which has a relatively uniform sensitivity to the sound waves in all directions, so that the sound waves can be received from any angle in the horizontal direction or from an upper side and a lower side within a certain vertical range. That is, the second receiving end of the omnidirectional microphone adopts an open structure design.

The diaphragms at the second receiving end of the omnidirectional microphone are usually designed at a relatively central position. The surrounding structure is relatively balanced, without any special obstruction or reinforcement design for a certain direction, so that the sound waves can uniformly reach the diaphragm from all directions, thereby receiving the sound waves in all directions.

Optionally, the inner wall of the sound wave reflection focusing structure 1223 of the collection portion 121 is covered with a layer of sound-absorbing material uniformly covered thereof. The layer of sound-absorbing material is capable of receiving the sound waves that enter the cavity of the sound wave reflection focusing structure 1223 and propagate to the inner wall thereof.

Optionally, the layer of sound-absorbing material can be made of a nanofiber composite material. The high porosity and frictional losses between fibers of the nanofiber composite material can absorb high-frequency sound waves. The layer of sound-absorbing is configured to suppress high-frequency standing waves while avoiding excessive attenuation of low-frequency energy of voices.

Optionally, the layer of sound-absorbing material can be made of graphene or graphene oxide thin films. A thickness of the graphene or graphene oxide film can be less than 0.1 mm, and high-frequency vibrations can be absorbed by using the flexibility and internal damping characteristics of the material.

In the embodiment, through the sound wave reflection focusing function of the concave structure, the sound wave direction selection and physical noise reduction are implemented at a hardware level, that is, the concave structure accurately reflects the sound waves in the specific direction range to the heart-shaped microphone at the center thereof to realize focusing gain, meanwhile, the sound waves outside the specific direction range are blocked from entering the sound wave reflection focusing structure 1223. The signals of the heart-shaped microphone (a main receiver) and the edge omnidirectional microphone (the auxiliary noise reference) are fused, combined with the spatial selectivity of the sound wave reflection focusing structure 1223, so that the hardware-level directional noise reduction and sound source separation are finally realized, the system directional noise reduction and voice enhancement capability is further integrally improved, and the quality of target voices is improved.

Referring to FIG. 2, in an embodiment of the present disclosure, each of the collection portions 121 is provided with a pilot lamp 15, and the collection device 1 is integrated with a real-time signal quality evaluation module based on FPGA; and wherein the real-time signal quality evaluation module is configured to:
obtain the audio formed by the sound waves that are collected by the microphone array 16 according to a first time interval, take the audio as a second audio, and calculate a real-time signal-to-noise ratio and a real-time signal strength of each collection portion 121 according to the second audio;
based on a preset dynamic signal-to-noise ratio threshold and a preset dynamic signal strength threshold, select N collection portions 121 with the highest weighted scores of the real-time signal-to-noise ratio and the real-time signal strength, wherein 0<N<P, and P is the total number of the collection portions 121;
control the pilot lamp 15 corresponding to each collection portion 121 that is selected to be lit up, and control the pilot lamps 15 of the remaining collection portions 121 to be turned off or be dim; and wherein
the dynamic signal-to-noise ratio threshold and the dynamic signal strength threshold are adaptively updated according to an environmental noise level of the environment where the collection device 1 is located.

Optionally, the real-time signal quality evaluation module based on the FPGA (field programmable gate array) is a circuit module that is specifically designed for performing real-time evaluation on signal quality.

Specifically, the audio formed by the sound waves that is the latest collected by the microphone array 16 is obtained according to a first time interval, to be taken as a second audio.

The first controller 13 is configured to control the pilot lamp 15 to be turned on or turned off.

The pilot lamp 15 can be set on the inner wall of the sound wave reflection focusing structure 1223 to illuminate the cavity of the sound wave reflection focusing structure 1223.

Extracting an average signal strength of the second audio as a real-time signal strength, first determining a signal power and a noise power in the second audio, and taking the logarithm of a ratio of the signal power to the noise power to obtain a signal-to-noise ratio, wherein the signal-to-noise ratio is taken as a real-time signal-to-noise ratio. For each collection portion 121, the real-time signal-to-noise ratio is compared with a dynamic signal-to-noise ratio threshold to obtain a signal-to-noise ratio comparison score, and the real-time signal strength is compared with a dynamic signal strength threshold to obtain an intensity comparison score. The signal-to-noise ratio comparison score and the strength comparison score are weighted and summed to obtain a composite score. Finally, the total scores of all the collection portions 121 are sorted, and N collection portions 121 are selected from the highest to the lowest direction. Based on a preset control strategy, the pilot lamps 15 that are selected and corresponding to each collection portion 121 are controlled to be lit up, and the pilot lamps 15 of the rest unselected collection portions 121 are controlled to be turned off or dimmed.

Obtaining the audio formed by the sound waves that are collected by the microphone array 16 according to a second time interval, taking the audio as an audio to be analyzed, calculating a short-time energy mean value of noise in the audio to be analyzed, and taking the short-time energy mean value as an environmental noise reference value N_ref;
a dynamic signal-to-noise threshold is provided as: SNRₜₕ=ρ⋅log₁₀(N_{ref}/N₀)+δ, wherein N₀ is reference noise, log₁₀ is a logarithmic function with a base of 10, and ρ, δ are experience coefficients; and
a dynamic signal strength threshold is provided as: Sₜₕ=γ·N_{ref}, wherein γ has a value range of 1.5-2.0, and is adaptively adjusted along with noise fluctuations.

In the embodiment, according to the audio that is obtain based on the first time interval, the signal-to-noise ratio and the signal strength of the collection portions 121 are calculated, and then the N collection portions 121 with the highest weighted scores are screened out. A status of each collection portion 121 can be visually displayed by controlling the on/off or brightness of the pilot lamp 15, so that it can conveniently and quickly identify and timely find problems to be adjusted. Moreover, the dynamic thresholds (that is the dynamic signal-to-noise ratio threshold and the dynamic signal strength threshold) are adaptively updated according to environmental noise, so that the evaluation is more fit with an actual environment, misjudgment of a fixed threshold in different environments can be avoided, and the reliability and stability of the audio formed by the sound waves that are collected by the whole system can be improved.

In an embodiment of the present disclosure, the real-time signal quality evaluation module is configured to:
obtain the audio formed by the sound waves that are collected by the microphone array 16 according to the first time interval, take the audio as the second audio, and calculate a real-time signal-to-noise ratio and a real-time signal strength of each collection portion according to the second audio;
based on a preset dynamic signal-to-noise ratio threshold and a preset dynamic signal strength threshold, select N collection portions with the highest weighted scores of the real-time signal-to-noise ratio and the real-time signal strength, wherein 0<N<P, and P is the total number of the collection portions 121; and
control the pilot lamp 15 corresponding to each collection portion 121 that is selected to be lit up, and control the pilot lamps 15 of the remaining collection portions 121 to be turned off or be dim.

The preset fixed signal-to-noise ratio threshold is a preset threshold. The preset fixed signal strength threshold is a preset threshold. By adopting the preset threshold, the computational resource can be reduced.

Referring to FIG. 2, in an embodiment of the present disclosure, the processing device 2 includes a first input member 24, the collection device 1 including a second input member 14, a direction detection member 17, and an image pickup member 18, wherein the system further includes a remote control 4 connected in communication with the collection device 1 or the processing device 2, and a collection control module is integrated with the collection device 1; and wherein
the collection control module is configured to:
obtain a main direction angle set by a user through any one of the first input member 24, the second input member 14, and the remote control 4 as a first direction;
take a current pointing direction of the collection device 1 that is detected by the direction detection member 17 as a second direction;
based on image data captured by the image pickup member 18, determine a face direction through a face recognition algorithm according to the image data, to be as a third direction;
determine a main collection direction and an auxiliary collection direction according to the first direction, the second direction and the third direction, to be as initial direction data;
determine whether to update the collection control data according to a deviation between the initial direction data and the collection direction data corresponding to the collection control data;
if the collection control data is needed to be updated, determine control data according to the initial direction data, to be as the updated collection control data, and update the collection direction data according to the initial direction data
according to the collection control data, control the microphone array 16 to collect the sound waves to form the audio as the first audio; and wherein
the collection control data includes the main collection data and the auxiliary collection data.

The second input member 14 can be arranged on the hand-held portion 11. The direction detection member 17 can be received in a receiving room inside the hand-held portion 11.

The image pickup member 18 can be set according to requirements, which is capable of photographing surrounding environments of the collection device 1. The image pickup member 18 can be installed on Pan&Tilt to capture images of the surrounding environment of the collection device 1. A plurality of image pickup members 18 can also be installed on the collection device 1 to capture images of the surrounding environment of the collection device 1. The second input member 14 and supporting structures (such as Pan&Tilt) can be selected from conventional technologies, which will not be repeated herein.

Each of the first input member 24 and the second input member 14 can be a button or a touch panel. The first controller 13 controls the second input section 14, the direction detection member 17, and the image pickup member 18 to be work or be out of work, and the second controller 21 controls the first input member 24 to be work or be out of work.

The remote control 4 is in communication connection with the collection device 1 or the processing device 2 through the Bluetooth technology.

The direction detection member 17 can be a gyroscope, or a magnetometer etc.

The direction detection member 17 is configured to obtain spatial orientation data of the collection device 1 in real time. According to the spatial orientation data of the collection device 1 and a corresponding relationship between the spatial orientation data and a default collection direction, the direction detection member 17 is configured to determine a sound wave source direction of the collection portion 121 that corresponds to the default collection direction, and take the sound wave source direction as the second direction. The direction detection member 17 typically includes a MEMS gyroscope (for measuring an angular velocity), an accelerometer (for detecting a three-dimensional acceleration), and a magnetometer (for sensing a direction of the geomagnetic field), which is configured to calculate a pitch angle, a yaw angle, and a roll angle (with an accuracy equal to or less than 1 °) of the collection device 1 by a sensor fusion algorithm (such as a kalman filtering way). The direction detection member 17 outputs direction data at a frequency of equal to or greater than 100 Hz.

The MEMS gyroscope (a micro-mechanical gyroscope) is a micro-sensor manufactured based on a micro-electro-mechanical system (MEMS) technology, which is mainly for measuring a rotational angular velocity.

The collection portion 121 corresponding to the default collection direction is the collection portion 121 that is intended to collect the sound waves formed by the speaker. The default collection direction can be preset when the collection device 1 is factory set, or can be input into the collection device 1 in advance by a user according to his own usage habit.

By analyzing real-time image data captured by the image pickup member 18, the face recognition algorithm is used to first locate facial feature points. And then, according to the relative position relations of key feature points such as eyes, nose, and mouth etc., calculating an angle of the face relative to the camera, thereby determining a direction of the face.

Optionally, the first direction can be a direction that is initially set or a direction set in real time, the second direction is from the direction detection member 17, and the third direction is related to the face. Comparing the relationship between the above three directions with a preset rule, for example, preferentially selecting the direction pointing to the face as the main collection direction, and determining other directions as the auxiliary acquisition directions after the other directions are weighted. If the first direction meets the main collection requirement, the first direction is directly determined, and then the auxiliary collection direction will be supplemented according to the second direction and the third direction, which are integrated to be taken as the initial direction data.

Optionally, the vectors (after unitization) of the first direction, the second direction and the third direction are overlapped and added according to weights by a vector synthesis method, and a synthesized direction vector is taken as the main collection direction. And symmetrically expanding a preset angle range on two sides of the main collection direction to form the auxiliary collection direction.

Optionally, when the deviation between any two directions of the first direction, the second direction and the third direction is greater than 60 °, the third direction is preferred as the main collection direction, and the preset angle ranges are symmetrically expanded on the two sides of the main collection direction to form the auxiliary collection direction.

Optionally, when the deviation between any two directions of the first direction, the second direction and the third direction is greater than 60 °, the pilot lamp 15 can be controlled to be lit up with different colors to remind the user to adjust the first direction or the second direction. That is, it is necessary that the pilot lamp 15 of the collection portion 121 that is corresponding to the first direction displays a first color, the pilot lamp 15 of the collection portion 121 that is corresponding to the second direction displays a second color, and the pilot lamp 15 of the collection portion 121 that is corresponding to the third direction displays a third color.

In the embodiment, firstly, through the plurality of input members and the remote control 4, the user can flexibly set the main direction angle, so as to improve convenience and diversity of setting the collection direction. Secondly, the multi-directional data is determined by combining the detection of the direction detection member 17 of the acquisition device 1 and the face recognition of the image pickup member 18, so that both the main collection direction and the auxiliary collection direction are determined more accurately. Furthermore, whether to update the collection control data is determined according to the deviation between the initial direction data and the existing collection direction data, so that self-adaptive adjustment of the collection control data is realized, and frequent updating the collection control data can be avoided under the condition that the collection direction is ensured to always meet the requirements. Finally, the microphone array 16 is controlled to collect the audio according to the updated collection control data, so that the audio in the target direction (the main collection direction and the auxiliary collection direction) can be collected more accurately, and the accuracy and the effectiveness of audio collection are improved.

Referring to FIG. 2, in an embodiment of the present disclosure, the collection device 1 includes at least three directional collection bits, and wherein the second receiving end of one of the omnidirectional microphones in the microphone array 16 is located in the directional collection bit; and wherein
the collection control module configured to determine the main collection direction and the auxiliary collection direction according to the first direction, the second direction and the third direction, to be as the initial direction data, includes:
taking the audio formed by the sound waves that are collected by the microphone corresponding to the receiving ends within the direction collection bits, to be as a positioning audio, and determining a sound source position according to the positioning audio to be used as a fourth direction; and
determining the main collection direction and the auxiliary collection direction that are determined by the first direction, the second direction, the third direction and the fourth direction, to be as the initial direction data.

The first direction, the second direction, the third direction, and the fourth direction adopt the same reference frame (such as a device coordinate system).

The direction collection bits can be all provided on the umbrella-shaped collection head 12, or can be provided partially on the umbrella-shaped collection head 12 and partially on the hand-held portion 11.

Optionally, there are eight direction collection bits annularly distributed on the periphery of the collection device 1, each two direction collection bits are spaced apart by an angle of 45 °, and a 360 °of omnidirectional range is covered. Each direction collection bit is provided with the omnidirectional microphone, and the receiving end of the microphone faces to a center of a corresponding angle (such as 0 °, 45 °, 90 °, 315 °).

Optionally, a preset time period is adopted to control the microphone corresponding to the receiving end in each direction collection bit to collect the sound waves to form the audio, and the audio is taken as a positioning audio.

The method of determining the sound source orientation by locating each sub-audio in the audio (the audio formed by the sound waves that are collected by the microphone corresponding to the receiving end in a direction collection bit) can be selected from the related art.

Optionally, an original audio signal (that is, the positioning audio) that is collected by each omnidirectional microphone is performed band-pass filtering (85 Hz-8 kHz), and then subjected to performing frame processing (a frame length of 20 ms, a frame shift of 10 ms) to extract short-time energy and a zero-crossing rate, environmental noise is primarily filtered out to obtain a preprocessing result, a generalized cross correlation (GCC-PHAT) algorithm is adopted to calculate a time delay difference (i.e., a time difference when two microphones receive the same sound wave) of the preprocessing results of adjacent microphone pairs; the sound source direction angle is solved by a least squares method according to the geometric position (a spacing: d=50 mm) and the time delay difference of the microphone pairs, a sound source orientation (it is also referred to as the sound source direction) is determined according to the sound source direction angle, and each sound source orientation corresponding to the positioning audio is taken as a fourth direction.

Optionally, the fourth direction includes at least zero sound source orientation.

Alternatively, the first direction can be the direction that is initially set or the direction that is set in real time, the second direction is from the direction detection member 17, the third direction is related to the face, and the fourth direction is related to a lip movement. Comparing the relationship between the four directions and the preset rule, for example, preferentially selecting the lip movement as the main collection direction, and determining other directions as the auxiliary collection directions after the other directions are weighted. If the fourth direction meets the main collection requirement, the fourth direction is directly determined, and then the auxiliary collection direction is supplemented according to the first direction, the second direction and the third direction, which are integrated to be taken as the initial direction data.

Optionally, the vectors (after unitization) of the first direction, the second direction, the third direction, and the fourth direction are overlapped and added according to weights by a vector synthesis method, and a synthesized direction vector is taken as the main collection direction. And symmetrically expanding a preset angle range on two sides of the main collection direction to form the auxiliary collection direction.

Optionally, when the deviation between any two directions of each sound source direction in the first direction, the second direction, the third direction, and the fourth direction is greater than 60 °, the sound source direction in the fourth direction is preferred as the main collection direction, and the preset angle ranges are symmetrically expanded on the two sides of the main collection direction to form the auxiliary collection direction.

Optionally, when the deviation between any two directions of the first direction, the second direction, the third direction, and the fourth direction is greater than 60 °, the pilot lamp 15 can be controlled to be lit up with different colors to remind the user to adjust the first direction or the second direction. That is, it is necessary that the pilot lamp 15 of the collection portion 121 that is corresponding to the first direction displays a first color, the pilot lamp 15 of the collection portion 121 that is corresponding to the second direction displays a second color, the pilot lamp 15 of the collection portion 121 that is corresponding to the third direction displays a third color, and the pilot lamp 15 of the collection portion 121 that is corresponding to the fourth direction displays a fourth color.

In the embodiment, the audio formed by the sound waves that are collected by the microphone corresponding to the receiving end in the direction collection bit determines the sound source direction, that is, the fourth direction, and the fourth direction is used in combination with the first direction, the second direction and the third direction to determine the collection direction data. This helps to more accurately locate the collection source and improve the collection accuracy thereof. The system can adapt to the collection requirements under complex environments, for example, when there is a plurality of sound sources and interference sources; through multi-direction comprehensive consideration, the error caused by single-direction judgment is avoided, the main collection direction is aligned to a main speaker, and the auxiliary collection direction is effectively supplemented, so that the overall performance of the collection device 1 can be optimized, relevant data of the main speaker can be better obtained, and the collection efficiency and quality can be improved.

Referring to FIG. 2, in an embodiment of the present disclosure, an aging compensation module is integrated with the processing device 2 and configured to:
obtain a compensation signal;
respond to the compensation signal, obtain preset control data as debugging control data, and update the collection control data of the collection device 1 according to the debugging control data;
control the processing device 2 to play a preset standard test audio and obtain a response audio corresponding to the standard test audio and collected by the collection device 1;
compare the response audio with the standard test audio in a frequency response curve to obtain frequency response difference data;
generate aging compensation data according to the frequency response difference data; and wherein
the collection control module configured to determine the control data according to the initial direction data, to be as the updated collection control data includes:
determining the control data according to the initial direction data, to be as initial control data; and
correcting the initial control data according to the aging compensation data to be taken as the updated collection control data.

The compensation signal is a signal that is configured to be initiated to determine the aging compensation data.

The compensation signal can be triggered through any one of the first input member 24, the second input member 14 and the remote control 4, or automatically triggered by the system according to preset time data.

Specifically, firstly, converting the response audio and the standard test audio into frequency domain signals, and obtaining frequency response curves corresponding to the response audio and the standard test audio respectively. For each frequency point, a difference between the amplitude value of the frequency response curve of the response audio and the amplitude value of the frequency response curve of the standard test audio is calculated. These differences constitute frequency response difference data. The audio signal (that is, the response audio, the standard test audio) can be converted to a frequency domain signal using a discrete Fourier transform (DFT) or a fast Fourier transform (FFT). And then, under the same frequency scale, the amplitudes of the two are compared point by point to accurately obtain the frequency response difference data, thereby reflecting change conditions of the audio acquisition characteristics of the collection device 1 caused by aging and other factors.

The playing member 22 of the processing device 2 is controlled to play the preset standard test audio. The second controller 21 controls the playing member 22 to be work or work out. The playing member 22 can be a speaker.

Optionally, according to the frequency response difference data, the aging compensation data can be determined by using a lookup table method.

Optionally, the frequency response difference data is input into a third model that is pre-trained for performing classification prediction, a vector element with the maximum value is extracted from predicted vectors, and the compensation data corresponding to the vector element that is extracted is taken as the aging compensation data.

The aging compensation data may be determined according to limited experiments, which will not be described in detail herein.

The third model that is pre-trained is a multi-classification model that is pre-trained. A model structure and a model training method of the third model can be selected from the related art.

Based on a preset correction formula, performing correction processing on the initial control data according to the aging compensation data, and taking the initial control data after being performed correction processing as the updated collection control data.

The preset correction formula can be fitted according to a plurality of test data, which is not described in detail herein.

In the embodiment, the aging compensation module is set to update the collection control data by obtaining the compensation signal, so as to ensure that the collection device 1 adapts to aging situations. Playing the standard test audio and comparing the response audio to obtain the frequency response difference data, and further generating the aging compensation data, which is helpful for accurately compensating the performance deviation of the collection device 1 caused by aging. When determining the collection control data, the aging compensation data and the initial direction data are synthesized, the initial control data is corrected, so that the acquisition accuracy and reliability are improved, the collection device 1 can keep stable performance in long-term use, and the influence of aging on the collection effect can be reduced.

Referring to FIG. 2, in an embodiment of the present disclosure, a directional noise reduction and voice enhancement module is integrated with the processing device 2 and configured to:
determine a directional noise reduction scheme according to the collection direction data;
perform directional noise reduction on the first audio according to the directional noise reduction scheme, to obtain a third audio; and
perform human voice separation and voice enhancement on the third audio to obtain the target voice.

Specifically, according to the collection direction data, the lookup table method is adopted to determine the directional noise reduction scheme.
a preset voice separation method is used to perform human voice separation on the third audio, a preset voice enhancement method is used to perform voice enhancement on data that is obtained by performing human voice separation, and the voice that has been enhanced is taken as the target voice.

The directional noise reduction scheme includes the following types of data: the collection direction data and noise reduction control parameters corresponding to each collection direction in the collection direction data.

In the embodiment, the directional noise reduction scheme is determined by the collection direction data, so that the first audio can be accurately subjected to being performed directional noise reduction to obtain the third audio, noise interference outside the main collection direction is effectively reduced, noise in the voices is more effectively suppressed, and the quality of the target voice is improved.

In an embodiment of the present disclosure, the directional noise reduction and voice enhancement module configured to perform directional noise reduction on the first audio according to the directional noise reduction scheme, to obtain the third audio, includes:
a multi-stage NLMS filter used to perform the directional noise reduction on the first audio according to the directional noise reduction scheme, to obtain the third audio; and wherein
the multi-stage NLMS filter includes three-stage parallel target filters and a fusion device, wherein the target filters sequentially include a Butterworth band-pass filter and an NLMS filter, and the fusion device is used for performing weighted fusion on the output of each of the target filters; and wherein
a frequency band P1 that is processed by a first-stage target filter is greater than 0Hz and less than or equal to a first frequency band, a step length factor is dynamically adjusted according to a formula: μ_1=α_1/(SNR_1+β_1), wherein α_1 and β_1 are empirical constants, and SNR_1 is the signal-to-noise ratio of data that is input into the target filter between 0 Hz and the first frequency band; and wherein
a frequency band P2 that is processed by a second-stage target filter is greater than the first frequency band and less than or equal to a second frequency band, a step length factor is dynamically adjusted according to a formula: μ_2=α_2/(SNR_2+β_2), wherein α_2 and β_2 are empirical constants, and SNR_2 is the signal-to-noise ratio of data that is input into the target filter between the first frequency band and the second frequency band; and wherein
a frequency band P3 that is processed by a third-stage target filter is greater than the second frequency band and less than or equal to a third frequency band, a step length factor is dynamically adjusted according to a formula: μ_3=α_3/(SNR_3+β_3), wherein α_3 and β_3 are empirical constants, and SNR_3 is the signal-to-noise ratio of data that is input into the target filter between the second frequency band and the third frequency band.

Specific values of the first frequency band, the second frequency band and the third frequency band can be set according to requirements, which are not limited herein.

Alternatively, the first frequency band is set to 1 kHz, the second frequency band is set to 4 kHz, and the third frequency band is set to 8 kHz.

Specifically, according to the directional noise reduction scheme, the noise reduction control parameters of each sub-audio in the first audio are determined, and when the multi-stage NLMS filter is used to process the sub-audio, the NLMS filter adopts the noise reduction control parameters corresponding to the sub-audio.

The Butterworth band-pass filter is mainly used to select a specific frequency range, for allowing signals within the frequency band to pass through while suppressing signals outside the frequency band. In the multi-stage NLMS filter system, the multi-stage NLMS filter system, which is served as the front-end part of a target filter, is used to perform preliminary frequency screening on the input first audio within a corresponding target frequency band (such as 0 Hz-1 kHz, 1-4 kHz, and 4-8 kHz), so that the subsequent NLMS filter can perform noise reduction operation better on the basis of the screened frequency band signals.

The NLMS filter (a normalized least mean square filter) is used to adaptively adjust coefficients of the filter to minimize errors between the desired signals and the output of the filter. In the system, the system receives the signals that are processed by the Butterworth band-pass filter, and dynamically adjusts the coefficients according to the statistical characteristics of the input signal, so that noise components in the corresponding frequency band are effectively removed, the quality of the voice signals in the frequency band is improved, and finally the directional noise reduction effect of the first audio in different frequency bands is realized.

The first-stage target filter is mainly configured to process environmental noise and be converged rapidly by using a larger step factor.

The second-stage target filter is configured to enhance voice clarity (a main energy region of a human voice), with a moderate step factor.

The third-stage target filter is configured to suppress sharp noise (e.g., a metal collision sound), with a smaller step to avoid distortion thereof.

A fusion device first receives the outputs of the NLMS filters from the three target filters. Then, according to preset weight coefficients, the coefficients can be set according to noise reduction requirements and the importance of different frequency bands. It is performed weighted operation on the output of each-stage of target filter, and weighted results are added, to finally obtain fused output (that is, the third audio), thereby realizing effective fusion of noise reduction results of different frequency bands.

The step factor of the target filter specifies a negative correlation relationship between the step and the signal-to-noise ratio, which is beneficial to reducing a convergence speed of the high-noise frequency band and avoiding signal distortion thereof.

α₁ and β₁can be obtained through limited experiments, α₂ and β₂ can also be obtained through limited experiments, and α₃ and β₃ be obtained through limited experiments.

In the embodiment, the multi-stage NLMS filter is used for performing directional noise reduction, which can accurate process different frequency bands. Different target filters are used to process frequencies ranging from 0 Hz to the first frequency band, from the first frequency band to the second frequency band, and from the second frequency band to the third frequency band. The step factor is dynamically adjusted according to the signal-to-noise ratio of the frequency band, which can effectively adapt to different input audios. The output of each stage of filter is weighted and fused through the fusion device, the noise reduction advantages of different frequency bands can be synthesized, the noise can be more accurately suppressed, and the target voice can be enhanced, so that the voice quality can be improved in the directional noise reduction process, to obtain the purer and more identifiable third audio.

In an embodiment of the present disclosure, the directional noise reduction and voice enhancement module configured to perform human voice separation and voice enhancement on the third audio to obtain the target voice, includes:
obtaining hearing preference parameters, wherein the hearing preference parameters comprise a sensitive frequency band and a volume tolerance threshold;
determining the voice enhancement scheme according to the hearing preference parameters and the collection direction data; and
performing voice separation and voice enhancement on the third audio according to the voice enhancement scheme, to obtain the target voice.

The hearing preference parameter is data that is input and stored in advance.

Optionally, the lookup table method is used to determine the voice enhancement scheme according to the hearing preference parameter and the collection direction data.

Optionally, the hearing preference parameter and the collection direction data are spliced and then input into a fourth model that is pre-trained for performing classification prediction, a vector element with the maximum value is extracted from the predicted vector, and a scheme corresponding to the vector element that has extracted is taken as the voice enhancement scheme.

The hearing preference parameters are obtained through a user input interface or a preset configuration file.

The fourth model that is pre-trained is a multi-classification model that is pre-trained. A model structure and a model training method of the fourth model can be selected from the related art.

The voice enhancement scheme includes a main direction voice main enhancement scheme and a main direction voice auxiliary enhancement scheme. The main direction voice main enhancement scheme is used for enhancing the voice in the main collection direction after performing human voice separation, to obtain the first voice, the main direction voice auxiliary enhancement scheme is used for correcting the voice in the auxiliary collection direction after performing human voice separation, to obtain the target voice.

In the embodiment, firstly, by introducing the hearing preference parameter, the voice enhancement scheme can be customized according to a sensitive frequency band and a volume tolerance threshold of individual's hearing, so as to improve the personalization of the scheme. Secondly, by combining the collected direction data, the voice in the specific direction can be processed more accurately. In the process of performing human voice separation and voice enhancement, the desired voice can be effectively enhanced, and the clarity and the comprehensibility of the voice can be improved. For users with special hearing requirements, such as the situation of sensitivity to certain frequency bands or limited volume tolerance, the target voice that is more in line with self-hearing characteristics can be obtained, to improve the voice experience of the users.

In an embodiment of the present disclosure, a conductive coating is coated on an outer surface of the other end of the collection device 1, and connected to the ground wire of the microphone array 16 to form an electromagnetic shielding circuit thereof.

Specifically, the conductive coating is coated on the outer surface of the other end of the collection device 1 by using a spraying process.

Alternatively, a surface resistivity of the conductive coating is less than or equal to 5 Ω/cm² in an environment of a temperature of 25 °C and a humidity of 50%.

In the embodiment, the conductive coating is made of a graphene composite material with a low surface resistivity, which can effectively conduct a current. The conductive coating and the ground wire of the microphone array 16 are connected to form an electromagnetic shielding loop, so that a good electromagnetic shielding effect can be achieved. The technology can reduce the influence of external electromagnetic interference on the collection device 1, ensure the purity of the audio signals that are collected, improve the accuracy and stability of audio acquisition, and improve the overall audio acquisition quality thereof.

It will be apparent to those skilled in the art that, for convenience and brevity of description, only the above-described division of the functional units and modules is illustrated as an example. In practical application, the above-described functional can be assigned to be performed by different functional units and modules according to requirements, that is, internal structures of the device can be divided into different functional units or modules to perform all or part of the above-described functions.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A directional noise reduction and voice enhancement system based on a microphone array comprising:
a collection device comprising the microphone array and configured to control the microphone array to collect sound waves to form a first audio based on collection control data corresponding to collection direction data;
a processing device configured to perform directional noise reduction and voice enhancement based on the first audio and the collection direction data to obtain a target voice; and wherein
an umbrella-shaped collection head is arranged on an end of the collection device and comprises at least four concave collection portions to form sound wave reflection and focusing structures, and a receiving end of at least one microphone of the microphone array is arranged within one of the sound wave reflection and focusing structures; and wherein the processing device comprises a first input member, the collection device comprising a second input member, a direction detection member, and an image pickup member, wherein the system further comprises a remote control connected in communication with the collection device or the processing device, and a collection control module is integrated with the collection device; and wherein
the collection control module is configured to:
obtain a main direction angle set by a user through any one of the first input member, the second input member, and the remote control, to be as a first direction;
take a current pointing direction of the collection device that is detected by the direction detection member, to be as a second direction;
based on image data captured by the image pickup member, determine a face direction through a face recognition algorithm according to the image data, to be as a third direction;
determine a main collection direction and an auxiliary collection direction according to the first direction, the second direction and the third direction, to be as initial direction data;
determine whether to update the collection control data according to a deviation between the initial direction data and the collection direction data corresponding to the collection control data;
if the collection control data is needed to be updated, determine control data according to the initial direction data, to be as the updated collection control data, and update the collection direction data according to the initial direction data;
according to the collection control data, control the microphone array to collect the sound waves to form the audio as the first audio; and wherein the collection control data comprises the main collection data and the auxiliary collection data.

2. The system as claimed in claim 1, wherein the types of microphones comprise a heart-shaped microphone and an omnidirectional microphone, wherein a first receiving end of the heart-shaped microphone is formed at a center of the sound wave reflection focusing structure, and at least one second receiving end of the omnidirectional microphone is formed on an edge of the sound wave reflection focusing structure.

3. The system as claimed in claim 1, wherein each of the at least four concave collection portions comprises a pilot lamp, and a real-time signal quality evaluation module based on FPGA (field programmable gate array) is integrated with the collection device; and wherein the real-time signal quality evaluation module is configured to:
obtain the audio formed by the sound waves that are collected by the microphone array according to a first time interval, take the audio as a second audio, and calculate a real-time signal-to-noise ratio and a real-time signal strength of each collection portion according to the second audio;
based on a preset dynamic signal-to-noise ratio threshold and a preset dynamic signal strength threshold, select N collection portions with the highest weighted scores of the real-time signal-to-noise ratio and the real-time signal strength, wherein 0<N<P, and P is the total number of the collection portions;
control the pilot lamp corresponding to each collection portion that is selected to be lit up, and control the pilot lamps of the remaining collection portions to be turned off or be dim; and wherein
the dynamic signal-to-noise ratio threshold and the dynamic signal strength threshold are adaptively updated according to an environmental noise level of the environment where the collection device is located.

4. The system as claimed in claim 1, wherein the collection device comprises at least three directional collection bits, and wherein the second receiving end of one of the omnidirectional microphones in the microphone array is located in the directional collection bit; and wherein
the collection control module configured to determine the main collection direction and the auxiliary collection direction according to the first direction, the second direction and the third direction, to be as the initial direction data, comprises:
taking the audio formed by the sound waves that are collected by the microphone corresponding to the receiving ends within the direction collection bits, to be as a positioning audio, and determining a sound source position according to the positioning audio to be used as a fourth direction; and
determining the main collection direction and the auxiliary collection direction that are determined by the first direction, the second direction, the third direction and the fourth direction, to be as the initial direction data.

5. The system as claimed in claim 1, wherein an aging compensation module is integrated with the processing device and configured to:
obtain a compensation signal;
respond to the compensation signal, obtain preset control data as debugging control data, and update the collection control data of the collection device according to the debugging control data;
control the processing device to play a preset standard test audio and obtain a response audio corresponding to the standard test audio and collected by the collection device;
compare the response audio with the standard test audio in a frequency response curve to obtain frequency response difference data;
generate aging compensation data according to the frequency response difference data; and wherein
the collection control module configured to determine the control data according to the initial direction data, to be as the updated collection control data comprises:
determining the control data according to the initial direction data, to be as initial control data; and
correcting the initial control data according to the aging compensation data to be taken as the updated collection control data.

6. The system as claimed in claim 1, wherein a directional noise reduction and voice enhancement module is integrated with the processing device and configured to:
determine a directional noise reduction scheme according to the collection direction data;
perform directional noise reduction on the first audio according to the directional noise reduction scheme, to obtain a third audio; and
perform human voice separation and voice enhancement on the third audio to obtain the target voice.

7. The system as claimed in claim 6, wherein the directional noise reduction and voice enhancement module configured to perform directional noise reduction on the first audio according to the directional noise reduction scheme, to obtain the third audio, comprises:
a multi-stage NLMS filter used to perform the directional noise reduction on the first audio according to the directional noise reduction scheme, to obtain the third audio; and wherein the multi-stage NLMS filter comprises three-stage parallel target filters and a fusion device, wherein the target filters sequentially comprise a Butterworth band-pass filter and an NLMS filter, and the fusion device is used for performing weighted fusion on the output of each of the target filters; and wherein
a frequency band P1 that is processed by a first-stage target filter is greater than 0 Hz and less than or equal to a first frequency band, a step length factor is dynamically adjusted according to a formula: μ_1=α_1/(SNR_1+β_1), wherein α_1 and β_1 are empirical constants, and SNR_1 is the signal-to-noise ratio of data that is input into the target filter between 0 Hz and the first frequency band; and wherein
a frequency band P2 that is processed by a second-stage target filter is greater than the first frequency band and less than or equal to a second frequency band, a step length factor is dynamically adjusted according to a formula: μ_2=α_2/(SNR_2+β_2), wherein α_2 and β_2 are empirical constants, and SNR_2 is the signal-to-noise ratio of data that is input into the target filter between the first frequency band and the second frequency band; and wherein a frequency band P3 that is processed by a third-stage target filter is greater than the second frequency band and less than or equal to a third frequency band, a step length factor is dynamically adjusted according to a formula: μ_3=α_3/(SNR_3+β_3), wherein α_3and β_3 are empirical constants, and SNR_3 is the signal-to-noise ratio of data that is input into the target filter between the second frequency band and the third frequency band.

8. The system as claimed in claim 6, wherein the directional noise reduction and voice enhancement module configured to perform human voice separation and voice enhancement on the third audio to obtain the target voice, comprises:
obtaining hearing preference parameters, wherein the hearing preference parameters comprise a sensitive frequency band and a volume tolerance threshold;
determining the voice enhancement scheme according to the hearing preference parameters and the collection direction data; and
performing voice separation and voice enhancement on the third audio according to the voice enhancement scheme, to obtain the target voice.

9. The system as claimed in claim 1, wherein a conductive coating is coated on an outer surface of the other end of the collection device, and connected to the ground wire of the microphone array to form an electromagnetic shielding circuit thereof.
